(19) United States
(12) Patent Application Publication
(10) Pub. No.: US 2020/0340075 A1
(43) Pub. Date: Oct. 29, 2020

(54) A COATED STEEL SUBSTRATE

(71) Applicant: ArcelorMittal, Luxembourg (LU)

(72) Inventors: Thi Tan VU, Oviedo (ES); Marcos PEREZ RODRIGUEZ, Cangas Del Narcea, Asturias (ES); Carlos LALIENA IRANZO, Oviedo, Asturias (ES); David NORIEGA PEREZ, Ovieda (ES)

(21) Appl. No.: 16/764,920

(22) PCT Filed: Dec. 11, 2018
(86) PCT No.: PCT/IB2018/059868

§ 371 Date: May 18, 2020

(30) Foreign Application Priority Data
Dec. 19, 2017 (IB) PCTIB2017/058103

(51) Int. Cl. C21D 9/46; B05D 7/14; C21D 8/02; C21D 6/00; C21D 1/70; C22C 38/50; C22C 38/46; C22C 38/44; C22C 38/42; C22C 38/04; C22C 38/02

(52) U.S. Cl. CPC C21D 9/46; C22C 38/02; C21D 8/0205; C21D 8/0226; C21D 6/004; C21D 6/005; C21D 6/008; C21D 8/0284; C21D 1/70; C22C 38/50; C22C 38/46; C22C 38/44; C22C 38/42; C22C 38/04; B05D 7/14

(57) ABSTRACT

A coated steel substrate including a coating comprising nanographite having a lateral size between 1 and 60 μm and a binder, wherein the steel substrate has the following compositions in weight percent: 0.31≤C≤1.2%, 0.1≤Si≤1.7%, 0.15≤Mn≤1.1%, P≤0.01%, S≤0.1%, Cr≤1.0%, Ni≤1.0%, Mo≤0.1%, and on a purely optional basis, one or more elements such as Nb≤0.05%, B≤0.003%, Ti≤0.06%, Cu≤0.1%, Co≤0.1%, N≤0.01%, V≤0.05%, the remainder of the composition being made of iron and inevitable impurities resulting from the elaboration and a method for the manufacture of the coated steel substrate.

The present invention relates to a steel substrate coated with a coating including nanographite, having a specific lateral size, and a binder, and/or to a method for the manufacture of this coated steel substrate. It is particularly well suited for steel industry.

### BACKGROUND

In the steel route production, after the steel making step, the steel is cast in a continuous casting. Semi-products, such as slabs, billets or blooms, are thus obtained. Usually, the semi-products are reheated at high temperature in a reheating furnace to dissolve precipitates formed during the continuous casting and to obtain a hot workability. The semi-products are then descaled and hot-rolled. However, during the reheating step, the semi-products can form scale due to oxidation. A high proportion of scale is usually formed. Thus, a large amount of scale is removed during a descaling step resulting in an important weight loss of the steel product.

The patent application CN101696328 discloses a protective coating for a surface of a steel piece in order to prevent the surface from oxidation and decarburization at high temperature and to improve hardness and abrasion resistance and ultimately increase the overall service life of the steel workpiece. For the case of oxidation and decarburization of a surface (substrate) of a steel workpiece at high temperature, and the surface oxidation decarburization under the oxidizing atmosphere during heat treatment, forging, hot rolling, roll forming heating, particularly for the case that the steel workpiece is easy to be oxidized and decarbonized at high temperature in a heat treatment, this can lead to reduction in carbon atoms and carbon content, and the change in the surface (substrate) microstructure results in a reduced hardness, a reduced abrasion resistance and a short overall service life.

In this patent, the coating has a composition of: graphite, water glass and surface penetrant, in which a volume ratio of the graphite to sodium silicate is 1:3 to 1:7, and the surface penetrant constitutes 0.05% to 0.15% by volume of the coating. Nevertheless, the tests were performed with low carbon steels including 25 (carbon steel) and HT300 (cast iron) and with very high alloy steels including 32CrMo and Mn13.

### SUMMARY OF THE INVENTION

It is an object of the present invention to provide a hot steel product with a specific steel composition wherein the weight loss due to the oxidation of semi-products during the reheating step is significantly reduced.

The present invention provides a coated steel substrate comprising a coating comprising nanographite having a lateral size between 1 and 60 μm and a binder, wherein the steel substrate has the following compositions in weight percent:
0.31≤C≤1.2%,
0.1≤Si≤1.7%,
0.15≤Mn≤1.1%,
P≤0.01%,
S≤0.1%,
Cr≤1.0%,
Ni≤1.0%,
Mo≤0.1%,
and on a purely optional basis, one or more elements such as
Nb≤0.05%,
B≤0.003%,
Ti≤0.06%,
Cu≤0.1%,
Co≤0.1%,
N≤0.01%,
V≤0.05%,
the remainder of the composition being made of iron and inevitable impurities resulting from the elaboration.

The invention also covers a method for the manufacture of the coated steel substrate.

The invention also covers a method for manufacture of the hot rolled steel product.

Finally, the invention covers the use of the hot rolled steel product.

### BRIEF DESCRIPTION OF THE DRAWINGS

To illustrate the invention, various embodiments and trials of non-limiting examples will be described, particularly with reference to the following Figure:

FIG. 1 illustrates an example of coated steel substrate according to the present invention.

FIG. 2 illustrates an example of one nanographite according to the present invention.

Other characteristics and advantages of the invention will become apparent from the following detailed description of the invention.

### DETAILED DESCRIPTION

The invention relates to a coated steel substrate comprising a coating comprising nanographite having a lateral size between 1 and 60 μm and a binder wherein the steel substrate has the following compositions in weight percent:
0.31≤C≤1.2%,
0.1≤Si≤1.7%,
0.15≤Mn≤1.1%,
P≤0.01%,
S≤0.1%,
Cr≤0.5%,
Ni≤0.5%,
Mo≤0.1%,
and on a purely optional basis, one or more elements such as
Nb≤0.05%,
B≤0.003%,
Ti≤0.06%,
Cu≤0.1%,
Co≤0.1%,
N≤0.01%,
V≤0.05%,
the remainder of the composition being made of iron and inevitable impurities resulting from the elaboration.

Without willing to be bound by any theory, it seems that a coating comprising nanographite having a lateral size between 1 and 60 μm and a binder on a steel substrate having the above specific steel composition acts like a barrier to the oxidation and therefore to the scale formation during the reheating of the coated steel substrate. The inventors have found that not only the steel composition but also the nature of coating plays an important role on the reduction of steel oxidation during a heating treatment.

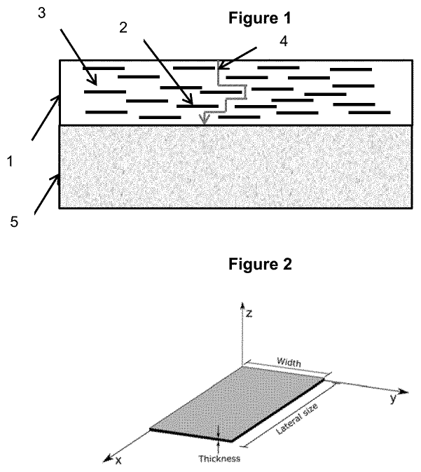

Additionally, as illustrated in FIG. 1, it is believed that in the coating (1) nanographite flakes (2) having this specific lateral size are well dispersed into the binder (3) so as to form of tortuous path (4). Thus, it seems that the oxygen diffusion through the coating is very restricted allowing an important reduction of the scale formation and a significant weight gain of the steel substrate. Finally, it is believed that the use of nanographites having the lateral size between 1 and 60 μm allows for a cluster including a large amount of nanographite flake resulting in a narrower space between each nanographite particle. Thus, the tortuous path is more difficult to cross reducing significantly the oxygen diffusion toward the steel substrate (5).

Regarding the chemical composition of the steel, preferably, the C amount is between 0.31 and 1.0% by weight.

Preferably, the Mn amount is between 0.15 and 0.7% by weight.

Advantageously, the amount of Cr is below or equal to 0.3% by weight.

Preferably, the amount of Ni is below or equal to 0.1% by weight.

Advantageously, the amount of Mo is below or equal to 0.1%.

FIG. 2 illustrates an example of nanographite flake according to the present invention. In this example, the lateral size means the highest length of the nanoplatelet so as to define the X axis and the thickness means the lowest height of the nanoplatelet so as to define the Z axis. The width of the nanoplatelet is illustrated through the Y axis.

Preferably, the lateral size of the platelet is between 20 and 55 μm and more preferably between 30 and 55 μm.

Preferably, the thickness of the coating is between 10 and 250 μm. For example, the thickness of the coating is between 10 and 100 μm or between 100 and 250 μm.

Advantageously, the steel substrate is a slab, a billet or a bloom.

Preferably, the binder is sodium silicate or the binder includes aluminum sulfate and an additive being alumina. In this case, without willing to be bound by any theory, it seems that the coating according to the present invention better adheres on the steel substrate so that the steel substrate is even more protected.

Thus, the risk of coating cracks and coating detachment, exposing the steel substrate to oxidation, is more prevented.

Preferably, the coating further comprises an organometallic compound. For example, the organometallic compound includes Dipropylene glycol monomethyl ether (CH₃OC₃H₆OC₃H₆OH), 1,2-Ethanediol (HOCH₂CH₂OH) and 2-ethylhexanoic acid, manganese salt (C₈H₁₆MnO₂). Indeed, without willing to be bound by any theory, it is believed that the organometallic compound allows for a fast curing of the coating avoiding a drying step at high temperature.

The invention also relates to a method for the manufacture of the coated steel substrate according to the present invention, comprising the successive following steps:
A. The provision of a steel substrate having the above steel composition,
B. The coating deposition using an aqueous mixture to form the coating,
C. Optionally, the drying of the coated steel substrate obtained in step B).

Preferably, in step B), the deposition of the coating is performed by spin coating, spray coating, dip coating or brush coating.

Advantageously, in step B), the aqueous mixture comprises from 1 to 60 g/L of nanographite and from 150 to 250 g/L of binder. More preferably, the aqueous mixture comprises from 1 to 35 g/L of nanographite.

Preferably, in step B), wherein the aqueous mixture comprises nanographite comprising above 95% and advantageously 99% by weight of C.

Advantageously, in step B), the ratio in weight of nanographite with respect to binder is below or equal to 0.3.

Preferably, in step B), the aqueous mixture comprises an organometallic compound. More preferably, the concentration of the organometallic compound is equal or below to 0.12 wt. %. Indeed, without willing to be bound by any theory, it is believed that this concentration allows for an optimized coating without any curing or with a curing at room temperature.

In a preferred embodiment, the coating is dried in a step C). Without willing to be bound by any theory, it is believed that the drying step allows for an improvement of the coating adhesion. Indeed, since water evaporates, the binder becomes tackier and more viscous leading to a hardened condition. In a preferred embodiment, in step C), the drying is performed at room temperature or a temperature between 50 and 150° C. and preferably between 80 and 120° C.

In another preferred embodiment, no drying step is performed.

Preferably, in step C), when a drying is applied, the drying step is performed with hot air.

Advantageously, in step C), when a drying is applied, the drying is performed during 5 to 60 minutes and for example, between 15 and 45 minutes.

The invention also relates to a method for manufacture of a Hot rolled steel product comprising the following successive steps:
I. The provision of the coated steel substrate according to the present invention,
II. The reheating of the coated steel substrate in a reheating furnace at a temperature between 750 and 1200° C.,
III. The descaling of the reheated coated steel sheet obtained in step II) and
IV. The hot-rolling of the descaled steel product.

The reheating is performed at a temperature between 750 and 1200° C.

Without willing to be bound by any theory, it is believed that above 1200° C., fayalite can be formed at the interface between the steel substrate and the coating. Preferably, in step II), the reheating is performed at a temperature between 750 and 900° C. or between 900 and 1200° C.

Preferably, in step III), the descaling is performed using water under pressure. For example, the water pressure is between 100 and 150 bars. In another embodiment, the descaling is performed mechanically, for example, by scratching or brushing the scale layer.

With the method according to the present invention, a hot rolled steel product having a high weight mass is obtained compared to the prior art.

For example, after the hot-rolling, the hot product can be coiled, cold-rolled, annealed in an annealing furnace and also coated with a metallic coating.

Finally, the invention relates to the use of a hot rolled steel product obtainable from the method according to the present invention for the manufacture of a part of an automotive vehicle, a rail, a wire or a spring.

The invention will now be explained in trials carried out for information only. They are not limiting.

### EXAMPLES

In Examples, steels substrates having the following steel composition in weight percent were used:

| Steel | C | Mn | Si | Cu | Cr | Ti | V | Mo | Ni |
|---|---|---|---|---|---|---|---|---|---|
| 1 | 0.0011 | 0.098 | 0.007 | 0.011 | 0.016 | 0.05 | 0.002 | 0.001 | 0.019 |
| 2 | 0.39 | 0.673 | 1.593 | 0.011 | 0.036 | 0.003 | 0.002 | 0.001 | 0.014 |
| 3 | 0.901 | 0.309 | 0.244 | 0.017 | 0.215 | 0.002 | 0.002 | 0.001 | 0.019 |
| 4 | 0.798 | 1.310 | 0.446 | 0.014 | 0.097 | 0.0014 | 0.0026 | 0.0018 | 0.016 |

Trial 1 was casted in the form of slab and Trials 2 to 4 were casted in the form of billet.

### Example 1: Oxidation Test

For Trials 1, 3, 5, 7, 9, 11, 13, 15 and 17, steels 1 to 4 were coated by spraying an aqueous mixture comprising 30 g/L of nanographite having a lateral size between 35-50 μm and a binder onto the steel. Then, the coating was dried during 30 minutes at 100° C.

Then, uncoated steels (Trials 2, 4, 6, 8, 10, 12, 14, 16 and 18) and coated steels (Trials 1, 3, 5, 7, 9, 11, 13, 15 and 17) were reheated at 800° C., 1000° C. and 1250° C. After the reheating, all the trials were weighted. For each Trial, Δweight was determined by subtracting the weight after reheating from the weight before the reheating. The percentage of weight gain of the coated Trial was then calculated with the following formula:

$$weight gain ( \% ) = 100 - ( \frac{Δ weight of coated trial \times 100}{Δ weight of uncoated trial} ) .$$

The results are in the following Table 1:

| | | | Reheating step | | | Weight |
|---|---|---|---|---|---|---|
| | | | temperature | | | gain |
| Trials | Steels | Coating | (° C.) | time | Δ Weight (g) | (%) |
| 1 | 1 | nanographite | 1000 | 3 h 20 min | 9.8 | 7 |
| | | and binder: | | | | |
| | | Na₂SiO₃ | | | | |
| | | (sodium silicate) | | | | |
| 2 | 1 | — | 1000 | 3 h 20 min | 10.5 | |
| 3 | 1 | nanographite | 1250 | 15 min | 12.19 | 5 |
| | | and binder: | | | | |
| | | Na₂SiO₃ | | | | |
| 4 | 1 | — | 1250 | 15 min | 12.78 | |
| 5 | 1 | nanographite | 1250 | 15 min | 32 | −7 |
| | | and Al₂(SO₄)₃ | | | | |
| | | (aluminum | | | | |
| | | sulfate) | | | | |
| 6 | 1 | — | 1250 | 15 min | 30 | |
| 7* | 2 | nanographite | 800 | 3h 20 min | 0.72 | 25 |
| | | and binder: | | | | |
| | | Na₂SiO₃ | | | | |
| 8 | 2 | — | 800 | 3h 20 min | 0.96 | |
| 9* | 2 | nanographite | 1000 | 3h 20 min | 6.3 | 23 |
| | | and binder: | | | | |
| | | Na₂SiO₃ | | | | |
| 10 | 2 | — | 1000 | 3 h 20 min | 8.2 | |
| 11* | 3 | nanographite | 800 | 1h 15 min | 0.17 | 43 |
| | | and binder: | | | | |
| | | Na₂SiO₃ | | | | |
| 12 | 3 | — | 800 | 1h 15 min | 0.3 | |
| 13* | 3 | nanographite | 1000 | 3h 20 min | 4.8 | 19 |
| | | and binder: | | | | |
| | | Na₂SiO₃ | | | | |
| 14 | 3 | — | 1000 | 3h 20 min | 5.9 | |
| 15 | 4 | nanographite | 1000 | 3 h | 0.57 | 11 |
| | | and binder: | | | | |
| | | Na₂SiO₃ | | | | |
| 16 | 4 | — | 1000 | 3 h | 0.64 | |
| 17 | 4 | nanographite | 1250 | 3 h | 12.10 | −3 |
| | | and binder: | | | | |
| | | Na₂SiO₃ | | | | |
| 18 | 4 | — | 1250 | 3 h | 11.75 | |

*: according to the present invention.

Trials according to the present invention show a significant increase of the percentage of weight gain. Indeed, the steel substrate having the specific steel composition according to the present invention is well protected with the coating during the reheating step.

1-24. (canceled)

25: A coated steel substrate comprising:
a coating including nanographite having a lateral size between 1 and 60 μm and a binder; and
a steel substrate having the following composition in weight percent:
0.31≤C≤1.2%,
0.1≤Si≤1.7%,
0.15≤Mn≤1.1%,
P≤0.01%,
S≤0.1%,
Cr≤1.0%,
Ni≤1.0%,
Mo≤0.1%,
and optionally at least one of the following elements:
Nb≤0.050%,
B≤0.003%,
Ti≤0.06%,
Cu≤0.1%,
Co≤0.1%,
N≤0.01%,
V≤0.05%,
a remainder of the composition being made of iron and inevitable impurities resulting from processing.

26: The coated steel substrate as recited in claim 25 wherein the lateral size of the nanoparticles is between 20 and 55 μm.

27: The coated steel substrate as recited in claim 26 wherein the lateral size of the nanoparticles is between 30 and 55 μm.

28: The coated steel substrate as recited in claim 25 wherein the thickness of the coating is between 10 and 250 μm.

29: The coated steel substrate as recited in claim 25 wherein the steel substrate is a slab, a billet or a bloom.

30: The coated steel substrate as recited in claim 25 wherein the binder is sodium silicate or the binder includes aluminum sulfate and an additive of alumina.

31: The coated steel substrate as recited in claim 25 wherein the coating further comprises an organometallic compound.

32: The coated steel substrate as recited in claim 31 wherein the organometallic compound includes at least one of the group consisting of: dipropylene glycol monomethyl ether (CH₃OC₃H₆OC₃H₆OH), 1,2-ethanediol (HOCH₂CH₂OH), 2-ethylhexanoic acid, and manganese salt (C₈H₁₆MnO₂).

33: A method for the manufacture of the coated steel substrate as recited in claim 25, the method comprising the successive following steps:
providing the steel substrate; and
depositing the coating via an aqueous mixture to form the coated steel substrate.

34: The method as recited in claim 33 further comprising drying the coated steel substrate.

35: The method as recited in claim 33 wherein the depositing is performed by spin coating, spray coating, dip coating or brush coating.

36: The method as recited in claim 33 wherein the aqueous mixture includes from 1 to 60 g/L of nanographite and from 150 to 250 g/L of binder.

37: The method as recited in claim 33 wherein the aqueous mixture includes nanographite including above 95% by weight of C.

38: The method as recited in claim 37 wherein the aqueous mixture comprises nanographite including an amount of C equal or above to 99% by weight.

39: The method as recited in claim 33 wherein a ratio in weight of nanographite with respect to the binder is below or equal to 0.3.

40: The method as recited in claim 33 wherein the aqueous mixture includes an organometallic compound.

41: The method as recited in claim 40 wherein a concentration of the organometallic compound in the aqueous mixture is equal or below to 0.12 wt. %.

42: The method as recited in claim 34 wherein the drying is performed at a temperature between 50 and 150° C. or at room temperature.

43: The method as recited in claim 34 wherein the drying step is performed with hot air.

44: The method as recited in claim 34 wherein the drying is performed for 5 to 60 minutes.

45: A method for manufacture of a hot rolled steel product comprising the following successive steps:
providing the coated steel substrate as recited in claim 25;
reheating the coated steel substrate in a reheating furnace at a temperature between 750 and 1200° C. to define a reheated coated steel sheet;
descaling of the reheated coated steel sheet to define a descaled steel product; and
hot-rolling the descaled steel product.

46: The method as recited in claim 45 wherein the reheating is performed at a temperature between 750 and 900° C.

47: The method as recited in claim 45 wherein the reheating is performed at a temperature between 900 and 1200° C.

48: The method as recited in claim 45 wherein the descaling is performed using water under pressure or the descaling is performed mechanically.

49: The method as recited in claim 48 wherein the descaling is performed using the water under a water pressure between 100 and 150 bars.

50: An automotive vehicle part, a rail, a wire or a spring manufactured according to the method as recited in claim 45.
